(19) United States
(12) Patent Application Publication
(10) Pub. No.: US 2014/0028262 A1
(43) Pub. Date: Jan. 30, 2014

(54) SECONDARY BATTERY PACK

(71) Applicants: Shigeru NOZAWA, Kanagawa (JP); Kazuhisa NAGASE, Kanagawa (JP)

(72) Inventors: Shigeru NOZAWA, Kanagawa (JP); Kazuhisa NAGASE, Kanagawa (JP)

(73) Assignee: NEC ENERGY DEVICES, LTD., Kanagawa (JP)

(21) Appl. No.: 13/963,308

(22) Filed: Aug. 9, 2013

Related U.S. Application Data
(62) Division of application No. 12/999,276, filed on Feb. 4, 2011.

(30) Foreign Application Priority Data
Jun. 16, 2008 (JP) 2008-156815

(51) Int. Cl. H02J 7/00; H01M 10/42

(52) U.S. Cl. CPC H02J 7/007; H01M 10/4207
USPC 320/128

(57) ABSTRACT

Provided is a secondary battery pack that determines, as for protection and controlling, the state of connection based on information input from external interfaces and switches a protection and control mode from one setting to another according to connection targets and situations. The secondary battery block of the present invention includes a secondary battery block having secondary batteries connected; a current detection section that monitors a charge and discharge current of the secondary battery block; an output voltage detection section that monitors the output voltage; a communication terminal; an ID terminal that detects a connection to a device; and a control section. The control section controls the charging and discharging of the battery pack, calculates capacitance and performs other processes to control the operation of the battery pack as a whole on the basis of electric potential/communication information from the communication terminal and device connection information from the ID terminal.

This is a divisional application based upon U.S. patent application Ser. No. 12/999,276 filed Feb. 4, 2011, which is a National Stage of International Application No. PCT/JP2009/060115 filed Jun. 3, 2009, claiming priority based on Japanese Patent Application No. 2008-156815 filed Jun. 16, 2008, the contents of all of which are incorporated herein by reference in their entirety.

### TECHNICAL FIELD

The present invention relates to a secondary battery pack that includes a control section which controls a charge or discharge switch of a secondary battery block having plurality of secondary batteries connected; and an external interface. The present invention particularly relates to a secondary battery pack having a function of enabling the protection and control conditions of secondary batteries to be separately set depending on a target device to be connected.

### BACKGROUND ART

The use of secondary batteries such as lithium-ion batteries has become widespread in recent years into such fields as electrically-powered equipment and storage of electricity. Demand is increasing for a function of performing protection and control processes that concentrate on the uses of individual main units of such equipment. At the same time, there is a great demand for securing long-term reliability and safety and improving battery longevity. In general, the setting of the battery pack's protection and control function that comprehensively allows the operating range determined by battery chargers or devices to be used is fixed in a way that allows the maximal range to be used for charging or discharging within the allowable range of the internal secondary batteries (also referred as cells). That is, the protection and control function are uniformly set based on the detection of connection to the devices, the state of current and the like. In general, one of the methods is to control the power consumption of a protection circuit on the basis of the detection of connection to the devices and the state of current. For example, what is proposed in Patent Document 1 is a technique of controlling the protection circuit's power consumption on the basis of the level of current of the battery pack. What is proposed in Patent Document 2 is a technique of controlling the protection circuit's power consumption on the basis of whether it is detected that the battery pack is connected to an electronic device. What is proposed in Patent Document 3 is a technique of controlling the protection circuit's power consumption on the basis of the level of voltage of a communication terminal.
Patent Document 1: JP-A-11-283677
Patent Document 2: JP-A-2001-155781
Patent Document 3: JP-A-2002-300731

### DISCLOSURE OF THE INVENTION

### Problems to be Solved by the Invention

FIG. 3 is a circuit configuration diagram illustrating an example of the configuration of a typical conventional secondary battery pack in which a number of secondary batteries are connected in series. In FIG. 3, the secondary battery pack includes a secondary battery block 2 in which secondary batteries 1 are connected in series; a current detection section 3 that monitors a charge and discharge current of the secondary battery block 2; a cell voltage detection section 4 that monitors the voltage of the secondary batteries 1; a communication terminal 6 that allows a temperature detection section 5 monitoring the temperature of the battery block 2 to communicate with devices and the like; an ID terminal 7 that detects a connection with devices; and a control section 8. The control section 8 controls the charging and discharging of the secondary battery pack, calculates capacitance and performs other processes to control the operation of the battery pack as a whole on the basis of voltage information of the secondary batteries 1 from the cell voltage detection section 4, current information from the current detection section 3, electric potential/communication information from the communication terminal 6, and device connection information from the ID terminal 7. The battery pack is also equipped with a charge switch (referred to as SW, hereinafter) 9 and discharge SW 10 that carryout an ON/OFF operation under the control of the control section 8.

Such a conventional secondary battery pack is effective in controlling the operating conditions of circuits on the basis of the current information from the current detection section 3, the voltage level/communication information from the communication terminal 6, and the device connection information from the ID terminal 7 and reducing the circuits' power consumption. However, the settings of the secondary battery pack's protection and other control processes are fixed exclusively for predetermined connection devices. Accordingly, if there are various devices to be connected, it is impossible to change the settings of the secondary battery pack's protection and other control processes in a way that goes best with each device.

Therefore, the object of the present invention is to provide a secondary battery pack that can provide the most appropriate settings of protection and control conditions of secondary batteries for each of target devices to be connected.

### Means for Solving the Problems

To achieve the above object, a secondary battery pack of the present invention includes a secondary battery block having a plurality of secondary batteries connected; a current detection section that monitors a charge and discharge current of the secondary battery block; an output voltage detection section that monitors the output voltage of the secondary battery block; a communication terminal to communicate with a connection device; an ID terminal that detects a connection to the connection device; and a control section that controls a charge switch and a discharge switch based on information from the current detection section, the output voltage detection section, the communication terminal and the ID terminal. The control section includes comparison means for comparing the information from the communication terminal or the ID terminal with a prescribed condition; determination means for determining the type of the connection device; and switching means for switching to a protection and control mode preset for each of the connection devices.

Moreover, the information from the communication terminal or the ID terminal may be transmitted from the electrically-connected connection device.

Moreover, the information from the communication terminal or the ID terminal maybe transmitted by magnetic or electric waves from the connection device in a non-contact manner.

Moreover, in the protection and control mode set for each of the connection devices, reference may be made to dedicated calculation processes and data tables that are set separately, and controlling and processing may be performed according to the type of connection devices and situations.

### Advantages of the Invention

As described above, according to the present invention, regarding the protection and control of the secondary battery pack, the type of a connection device is determined based on information input from external interfaces such communication terminals and ID terminals, making it possible to switch the protection and control mode from one setting to another according to connection targets and situations. Therefore, controlling is made possible by one secondary battery pack so as to be suitable for areas where various connection devices are used; it is possible to effectively make use of electric properties of the secondary battery pack such as capacitance and discharge current.

### BRIEF DESCRIPTION OF THE DRAWINGS

FIG. 1 is a circuit configuration diagram illustrating the configuration of a secondary battery pack according to an embodiment of the present invention.

FIG. 2 is a control flowchart illustrating a determination process of the secondary battery pack according to an embodiment of the present invention.

FIG. 3 is a circuit configuration diagram illustrating an example of the configuration of a conventional secondary battery pack.

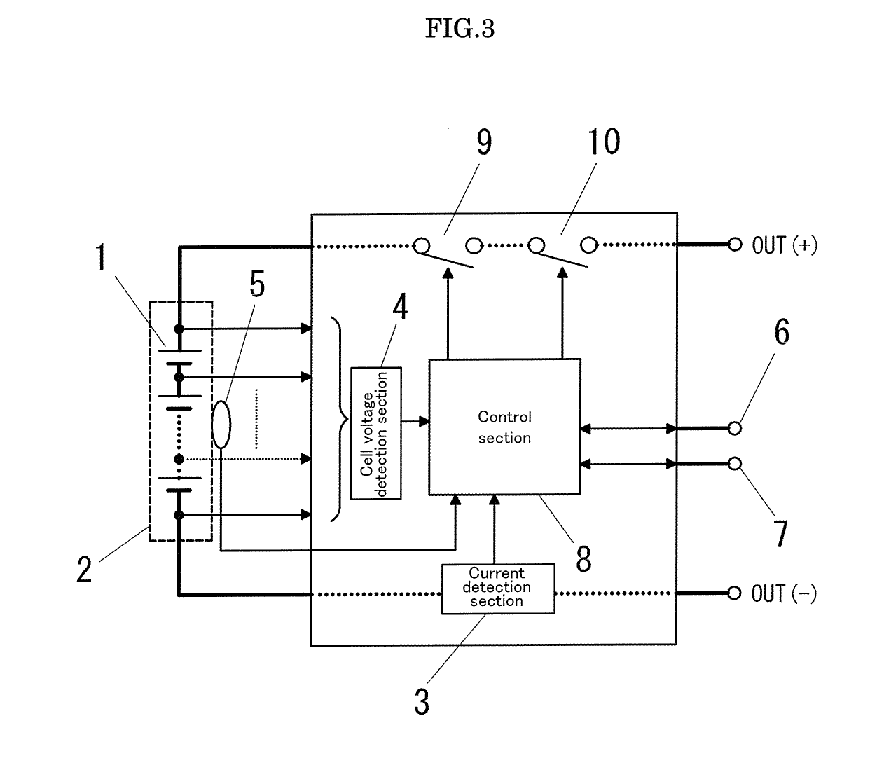

### EXPLANATION OF REFERENCE SYMBOLS

1, 11: Secondary battery
2, 12: Secondary battery block
3, 13: Current detection section
4, 14: Cell voltage detection section
15: Output voltage detection section
5, 16: Temperature detection section
6, 17: Communication terminal
7, 18: ID terminal
8, 19: Control section
9, 20: Charge SW
10, 21: Discharge SW

### BEST MODE FOR CARRYING OUT THE INVENTION

Hereinafter, an embodiment of the present invention will be described with reference to the accompanying drawings.

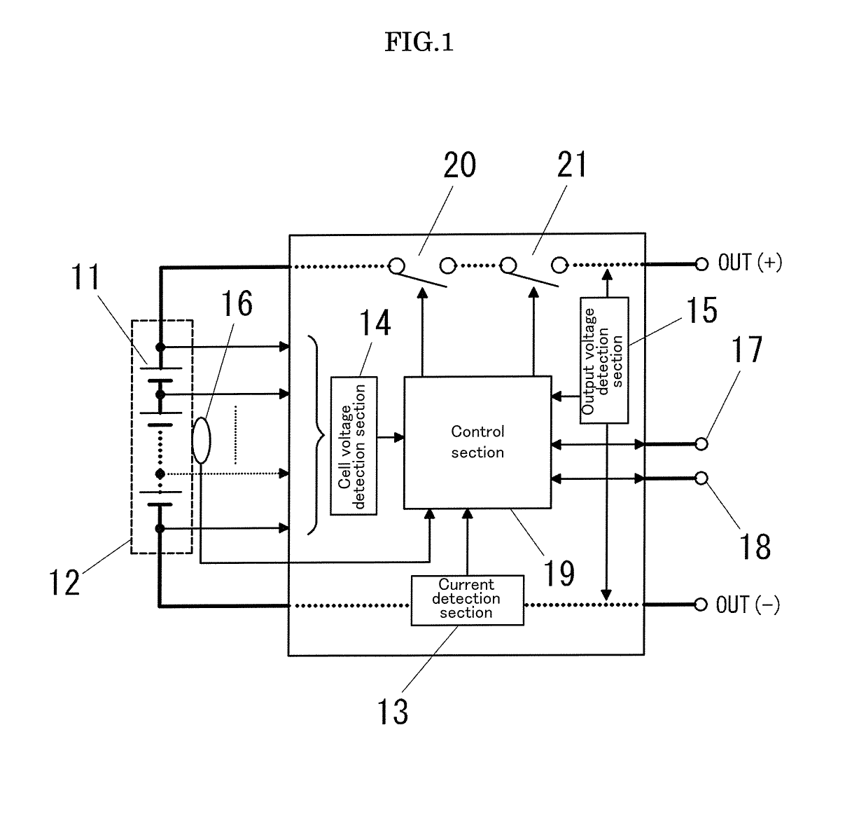

FIG. 1 is a circuit configuration diagram illustrating the configuration of a secondary battery pack according to an embodiment of the present invention. In FIG. 1, the secondary battery pack includes a secondary battery block 12 having a plurality of secondary batteries 11 connected in series; a current detection section 13 that monitors a charge and discharge current of the secondary battery block 12; a cell voltage detection section 14 that monitors the voltage of the secondary batteries 11; an output voltage detection section 15 that monitors the output voltage of the battery pack; a communication terminal 17 that allows a temperature detection section 16 monitoring the temperature of the secondary battery block 12 to communicate with connection devices and the like; an ID terminal 18 that detects a connection to a device; and a control section 19. The control section 19 controls the charging and discharging of the battery pack, calculates capacitance and performs other processes to control the operation of the battery pack as a whole on the basis of voltage information of the secondary batteries 11 from the cell voltage detection section 14, current information from the current detection section 13, electric potential/communication information from the communication terminal 17, and device connection information from the ID terminal 18. The secondary battery pack is also equipped with a charge SW 20 and discharge SW 21 that carry out an ON/OFF operation under the control of the control section 19.

According to the present embodiment, the control section 19 has a function of: making a determination as to a connection with a dedicated device, whether the secondary battery pack is running independently, the state of connection with any devices other than dedicated devices, and the type of a connection device in a collective manner on the basis of information from the communication terminal 17 and the ID terminal 18 as well as the information about current, voltage, and temperature from the current detection section 13, the cell voltage detection section 14, the output voltage detection section 15, and the temperature detection section 16 at the time; and performing protection, control and calculation processes in accordance with a data table prepared for each connection state or each type of connection device. Moreover, the control section 19 includes an internal memory and has a function of storing data tables and recording use environments, calculation results and error logs.

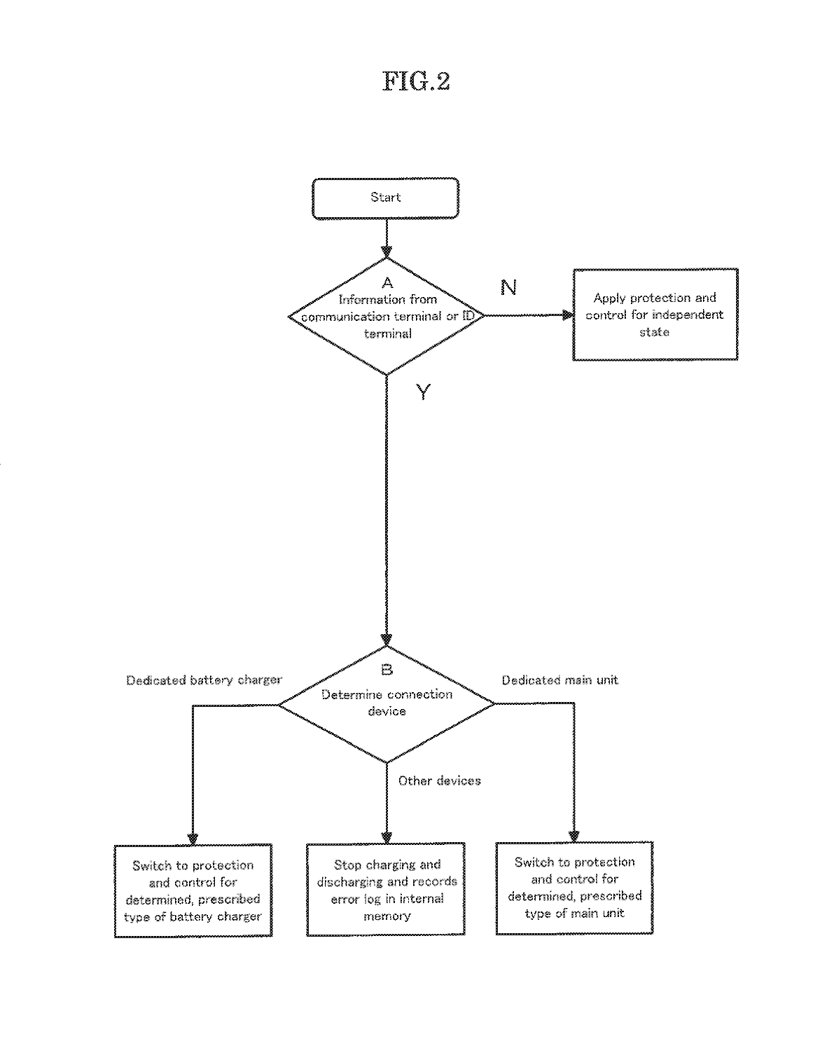

The following describes operation modes of the secondary battery pack according to the present embodiment. FIG. 2 is a flowchart illustrating how the secondary battery pack is controlled, according to an embodiment of the present invention.

As for the secondary battery pack illustrated in FIG. 1, in a first operation mode, the control section 19 makes a determination of A in the flowchart illustrated in FIG. 2 on the basis of information from the communication terminal 17 and the ID terminal 18. That is, based on the information about the electric potential of the communication terminal, what is communicated, the electric potential of the ID terminal, and the like, the control section 19 makes a determination as to whether the secondary battery pack is running independently or is connected to a device. When the information from the communication terminal 17 and the ID terminal 18 does not satisfy prescribed conditions about the presence of a connection device, it is determined that the secondary battery pack is in an independent state. Therefore, a control process for the independent state is applied for controlling protection and calculation. As the prescribed values of independent state based on which a determination is made by the control section 19, the condition that communication is not established with the electric potential of the communication terminal 17 less than or equal to 1V or the condition that the electric potential of the ID terminal is less than or equal to 1V may be set.

In a second operation mode, when the information from the communication terminal 17 and the ID terminal 18 satisfies the prescribed conditions about the presence of a connection device, the control section 19 makes a determination of B in the flowchart illustrated in FIG. 2. That is, by comparing prescribed determination values with the information about the electric potential of the communication terminal, what is communicated, the electric potential of the ID terminal, and the like, the control section 19 makes a determination as to whether the connection device is a dedicated battery charger, a dedicated main unit, or any other device. When it is determined that the connection device is a dedicated battery charger, the control section 19 makes reference to a preset data table on the basis of the type of battery charger determined from the communication information from the communication terminal 17 or the electric potential information from the ID terminal 18; and then switches to a setting of the corresponding type in terms of protection, control and calculation operation. When it is determined that the connection device is a dedicated main unit, the control section 19 makes reference to a preset data table on the basis of the type of main unit determined from the communication information from the communication terminal 17 or the electric potential information from the ID terminal 18; and then switches to a setting of the corresponding type in terms of protection, control and calculation operation. When it is determined that the connection device is any other device, the control section 19 turns off the charge SW 20 and the discharge SW 21 to stop the charge and discharge function, thereby preventing the battery pack from being used for any devices other than the dedicated devices. The control section 19 also records an error log in the internal memory.

As the prescribed values of the connection state of the dedicated devices (battery charger and main unit) based on which a determination is made by the control section 19, the condition that communication is established with the electric potential of the communication terminal 17 greater than or equal to 4V or the condition that the electric potential of the ID terminal is at a prescribed level, such as 3V or 5V, in the range from 2V to 10V may be set. As the prescribed values of the connection state of other devices based on which a determination is made by the control section 19, the condition that communication is not established with the electric potential of the communication terminal 17 greater than or equal to 4V or the condition that the electric potential of the ID terminal is not at a prescribed level, such as 4V or 7V, in the range from 2V to 10V may be set. As the data tables to which the control section 19 makes reference when determining that the device is a dedicated device (battery charger/main unit) and switching to a setting of the corresponding type of device in terms of protection, control and calculation operation, the following may be set for charging: the type of battery charger, information about whether pulse charging takes place, information about whether regenerative charging takes place, over-current detection current, over-current detection delay time, over-charge detection voltage, over-charge detection delay time, charge protection detection temperature, charge protection temperature detection delay time, low-voltage charge protection detection voltage, and low-voltage charge protection detection delay time. For discharging, the following may be set: the type of main unit, information about whether pulse discharging takes place, over-current detection current, over-current detection delay time, over-discharge detection voltage, over-discharge detection delay time, discharge protection detection temperature, and discharge protection temperature detection delay time.

When the state of the communication terminal 17 and the ID terminal 18 changes as the battery pack is removed from or attached to the device, initial values are restored as the setting for protection, control and calculation. Then, a series of the above processes from the first operation mode takes place in accordance with each determination condition to review the connection state and the type of the device connected for reset.

As for the determination of the state of connection devices and of protection, control and calculation operation, a determination is made as to a connection with the dedicated devices, whether the secondary battery pack is running independently, the state of connection with any devices other than the dedicated devices, and the type of connection devices in a collective manner on the basis of the information about current, voltage, and temperature from the current detection section 13, the cell voltage detection section 14, the output voltage detection section 15, and the temperature detection section 16 at the time as well as the connection information from the communication terminal 17 and the ID terminal 18. In accordance with the data table prepared for each connection state or each type of connection device, the setting may be done in terms of protection, control and calculation operation.

By confirming whether the information input from the external interfaces satisfies the prescribed determination conditions and the changes in the charge and discharge current and the output terminal voltage at the time, the control section 19 makes a determination as to a connection with the dedicated devices, whether the secondary battery pack is running independently, and the state of connection with any devices other than the dedicated devices; and then switches the protection and control mode from one setting to another according to connection targets and situations when controlling the secondary battery pack.

The information from the communication terminal and the ID terminal may be transmitted by means of magnetic or electric waves from connection devices in an non-contact manner. For example, when magnetic waves are used for transmission, a magnetic body of the battery pack is aligned with a magnetic body of a dedicated device. As the magnetic body draws near, a contact switch of the receiver is turned on to generate a change in electric potential level and transmit a prescribed fixed level or pulse. Therefore, a determination is made as to whether the device is a dedicated device and the control mode is switched. When electric waves are used for transmission, the communication information and the ID information are transmitted by a dedicated transmission/reception/conversion device according to a prescribed radio communication protocol. Depending on whether communication is established and whether pieces of transmission information are transmitted in a prescribed order and with the prescribed content, a determination is made as to whether the device is a dedicated device and the control mode is switched.

### INDUSTRIAL APPLICABILITY

The present invention relates to a secondary batter pack such as lithium-ion battery, the use of which has become widespread in recent years into such fields as electrically-powered equipment and storage of electricity. The protection and control function of such a secondary battery pack is uniformly set based on the detection of connection to the devices, the state of current and the like in a way that allows the maximal range to be used for charging or discharging within the allowable range of the internal secondary batteries (also referred as cells). According to the present invention, as for the protection and controlling of the secondary battery pack, the type of the connection device is determined based on the information input from the external interfaces such as the communication terminal and the ID terminal; it is possible to switch the protection and control mode from one setting to another according to connection targets and situations. Therefore, controlling is made possible by one secondary battery pack so as to be suitable for areas where various connection devices are used;

it is possible to effectively make use of electric properties of the secondary battery pack such as capacitance and discharge current. Thus, the secondary battery pack is extremely useful for industrial purposes.

1. A method of protection and control mode switching for a battery pack comprising a communication or an ID terminal, said method comprising the process of:
determining process as to whether the battery pack is running independently or is connected to a device, wherein the determination is made through the comparison of information of the communication terminal or the ID terminal with prescribed conditions; and
determining process as to whether the connection device is a dedicated battery charger, a dedicated main unit, or any other device, wherein the determination is made through the comparison of information of the communication terminal or the ID terminal with prescribed conditions.
